(19) United States
(12) Patent Application Publication
(10) Pub. No.: US 2021/0316202 A1
(43) Pub. Date: Oct. 14, 2021

(54) DEVICE FOR DETECTING THE IMPACT QUALITY IN CONTACT SPORTS

(71) Applicant: BLUE DANUBE ROBOTICS GMBH, Wien (AT)

(72) Inventors: Michael ZILLICH, Wien (AT); Dominik HÖLBLING, Wien (AT); Tobias FERNER, Wien (AT); Andreas BALDINGER, Wien (AT); Walter WOHLKINGER, Wien (AT)

(21) Appl. No.: 17/271,857

(22) PCT Filed: Aug. 30, 2019
(86) PCT No.: PCT/AT2019/000026

§ 371 Date: Feb. 26, 2021

(30) Foreign Application Priority Data
Aug. 30, 2018 (AT) A 266/2018

(51) Int. Cl. A63B 71/14; A63B 71/10; A63B 71/12; G01L 5/00

(52) U.S. Cl. CPC A63B 71/145; A63B 71/10; A63B 71/1225; G01L 5/0052; A63B 2071/1283; A63B 2220/53; A63B 2220/833; A63B 2244/102; A63B 2220/40

(57) ABSTRACT

A device for detecting the impact quality in contact sports comprises at least one sensor for detecting a force acting on a training device and at least one sensor for detecting an acceleration of the training device, wherein the force sensor comprises a fluid-filled, elastically deformable sensor body, in which a pressure sensor measuring the fluid pressure is arranged.

The invention relates to a device for detecting the impact quality in contact sports and a method for producing such a device.

An objective assessment of the impact quality is desirable in various contact sports both for assessing the success of training and for awarding points in competitions. In addition, an application in a scientific context for carrying out biomechanical or training-science studies is advantageous.

Contact sports include sports whose rules require or allow mutual physical contact between the competitors or teams involved. The invention relates particularly, but not exclusively, to contact sports, the rules of which provide for the placement of strokes or punches with a part of the body of the athlete, for example with the arms, hands, legs or feet. In particular, this includes martial arts, such as boxing, in which the punches are intended to hit a target, such as an opponent or a training object, as forcefully or as effectively as possible.

The quality of an impact includes both the force or the impulse acting on the target as well as the impact speed or the acceleration or deceleration and the direction of impact (as an indicator for the punching technique) in order to be able to assess the transmission of impulses.

WO 03/063119 A2 very generally describes a system consisting of a piece of sports equipment, such as a boxing glove, with an embedded force sensor, a wireless transmission unit, a receiver and display devices. The actual force sensor can be designed as a piezocapacitive sensor or as a pressure sensor filled with gas, liquid or gel. The exact mode of operation of the force sensor is not detailed here. The impact speed is not included here, which leads to measurement errors and reduces the assessment of the effectiveness of a punch.

US 2014/0248594 A1 describes a system consisting of a boxing glove and an embedded acceleration sensor, which primarily serves to determine the change in position of the athlete's hands in order to be able to assess the correct covering posture. Signals from the acceleration sensor are transmitted wirelessly to a receiver. It is also mentioned that either the glove or an externally mounted punching surface can contain a force sensor, the precise mode of operation of this force sensor again not being specified.

A solution is known from DE 44 26 302 A1, consisting of a punching surface, a resilient support device for the punching surface and an acceleration sensor connected to the punching surface. A path-dependent static force-time curve and an acceleration-dependent dynamic force-time curve can be measured using the flexibility and mass moments of inertia of the entire structure to be determined from a calibration. For example, an application to punch pads, combat vests or a device attached to the wall is proposed. Since these calibrations are hardly possible in practice, especially for hand-held punch pads or combat vests, this system is effectively limited to fixed devices.

WO 2000/048692 A1 describes a solution for the detection of punches in martial arts such as Taekwondo. The system consists of an elastic, damping layer, preferably polyurethane, and airtight tubular cavities embedded therein. These tubes are connected to a pressure measuring device via a common collecting chamber. This layer is worn by the athlete as a kind of vest. When exposed to a punch, some of these tubes are compressed, causing the air pressure in them to rise. This pressure fluctuation is passed on to the pressure measuring device via the collecting chambers. Throttle-like constrictions in the tubes in the transition area to the collecting chambers ensure that the pressure does not escape too quickly into the respective uncompressed tubes. The elastic polyurethane layer finally provides for a recovery after the end of the punch. The inventors also mention their use in other devices such as punch pads, boxing gloves, head guards and the like. The large and complex airtight space, the built-in throttles and the necessity of pressure transmission via a channel structure, however, lead to falsifications in the transmission of pressure waves to the pressure measuring device and therefore to pressure curves that are not representative of the respective impact.

The exact assessment of the quality of an impact is very difficult, since the quality of an impact depends on many physical and anatomical factors, such as the masses of the “projectile” (fist and arm or leg and foot) and of the body hit, the damping properties of the respective surfaces, the properties of the tissue hit, etc. In general, however, the force as well as the speed and the duration of contact with which the target is hit count for the impact of a punch.

The aim of the present invention is therefore to create a device for detecting the impact quality in contact sports, which allows the most comprehensive possible assessment of a punch with small-sized means. The device should preferably be attachable to the punching surface of the part of the body performing the punch in order to achieve the most direct and undistorted measurement results possible. Furthermore, such a device should be mobile so that it can be carried by the athlete without affecting the athlete. Furthermore, the device should be robust in order to withstand repeated impacts undamaged and without loss of measurement accuracy.

To solve this object, the invention provides a device for detecting the impact quality in contact sports, which comprises at least one force sensor for detecting a force acting on a training device and at least one acceleration sensor for detecting an acceleration of the training device, wherein the force sensor comprises a fluid-filled, elastically deformable sensor body, in which a pressure sensor measuring the fluid pressure is arranged.

The invention is based on the knowledge that the combination of a force and an acceleration measurement allows an improved description of the impact quality. For example, it turns out that although the punches of Olympic light and heavyweight boxers have similar impact speeds and accelerations, the punches of the heavyweight boxers have significantly higher forces. From this one can conclude that a consideration of the accelerations alone is not sufficient.

Furthermore, impacts that have a lower impact acceleration but a longer impact duration have a similar effect on the victim as impacts with higher impact acceleration and shorter impact duration. Acceleration sensors alone are not sufficient for this either, since they cannot measure the duration of the impact, i.e. the time of the actual force transmission.

Furthermore, it was shown that the position of the fist, and thus the type of execution of the punch, has an influence on the impact quality. Here, acceleration sensors can provide the position and the speed of the fist (via integration of the acceleration values) during the execution of the punch and, together with the measured impact quality, provide valuable feedback for the training.

Conventional types of acceleration sensors can be used to measure the acceleration. Acceleration sensors are usually based on the principle that the inertial force acting on a test mass is determined. This can be used to determine whether an increase or decrease in speed is taking place. Miniaturized acceleration sensors in the form of micro-electro-mechanical systems (MEMS) are preferably used.

In order to measure the force acting during the execution of the impact, a force sensor is provided according to the invention, which is characterized by an extremely simple and robust design and whose measuring principle ensures an unadulterated and direct force determination. The force sensor includes a fluid-filled, elastically deformable sensor body in which a pressure sensor measuring the fluid pressure is arranged. The fluid is arranged in a closed cavity or a closed chamber of the sensor body, so that an external force acting on the sensor body leads to a deformation or compression of the same. The compression causes an increase in the fluid pressure inside the closed chamber, which is in a predetermined ratio to the acting force, so that the values determined by the pressure sensor allow a direct conclusion about the force.

In order to obtain an unadulterated measurement, it is essential that the pressure sensor is arranged in the deformable, fluid-filled sensor body. The pressure sensor is therefore not arranged in a chamber which is connected to the deformable sensor body, for example via a channel, and which is not exposed to the impact to be detected.

Preferably, the sensor body comprises a gas-filled chamber which is surrounded by a flexible shell deformable by impact and contains an elastic support structure, the support structure forming a damping element which mechanically dampens the forces that occur during impact. The elastic support structure preferably comprises an open porosity, so that the fluid cart be distributed unhindered. The support structure is responsible for resetting the sensor body after the deformation caused by an impact and can be formed, for example, from a foam or any three-dimensional, network-like structure.

It is preferably provided that the elastic support structure at least partially surrounds the pressure sensor. The pressure sensor is thus embedded in the support structure.

According to a preferred embodiment of the invention, the measured values of the force sensor and of the acceleration sensor are fed to a detection unit which is designed to record a time series of the measured values of the force sensor and the acceleration sensor. The detection unit can be designed as a microcontroller, for example.

If the athlete hits a target with the training device on or in which the device according to the invention is formed or attached, or if the training device is hit, the sensor body is compressed and the pressure sensor located in the sensor body measures the resulting increase in internal pressure. At the same time, the acceleration sensor measures the strong deceleration resulting from the impact. The time series of these two measured values are collected and preprocessed by the microcontroller and can preferably be transmitted via a connected transmission unit to an evaluation unit, where these values are interpreted using standardized pressure/acceleration force curves and then displayed to the athlete. The transmission of the measured values or series of measured values to the evaluation unit takes place preferably wirelessly, in particular via short-range radio, such as via Bluetooth.

Furthermore, the time series of the acceleration sensor can be recorded during the punching movement and transmitted to the evaluation unit in order to determine parameters of the punching technique and to give the athlete feedback about the correct execution of the punch. A theoretical impact force can also be predicted from the acceleration curve of the punch, taking into account the body weight of the athlete, and serve as a reference for the measured impact force in order to be able to detect any incorrect measurements.

The data thus determined allow the athlete to improve his/her training. In addition, the athlete can compare his/her determined training data with those of other athletes using appropriate online services. The system can also be used for games in conjunction with virtual reality headsets. Two or more athletes can use a punching bag or similar to fight against each other by comparing the strength data of both participants. Conversion factors can create comparability between people with different requirements (weight, height, age, etc.).

As far as the construction of the device according to the invention is concerned, it can preferably be provided that not only the pressure sensor but also the acceleration sensor is arranged in the interior of the sensor body. This leads to a particularly compact design in which the acceleration sensor is also located in a protected environment. Alternatively, the acceleration sensor can also be arranged outside the sensor body.

In both cases, the pressure sensor and the acceleration sensor can preferably be arranged on a common carrier, in particular on a common circuit board.

As already mentioned, it is preferably provided that the force sensor and the acceleration sensor are integrated, in particular embedded, into a training device. In particular, the force sensor and the acceleration sensor are embedded, in particular sewn into, a boxing glove, a punch pad, a protective vest or a foot protector as a training device.

The force sensor and possibly the acceleration sensor are preferably surrounded by a damping layer, in particular a layer of plastic foam. In particular, the damping layer on the side of the sensors facing the impact and on the side facing away from the impact is formed with the same layer thickness so that the measurement results remain comparable regardless of the impact side.

The material of the damping layer in this case dampens the effect of an impact, the more so the thicker the damping layer is. For precise and repeatable measurement results, it is advantageous if the sensor body is surrounded by a constantly thick layer of the damping layer in the region of the impact area. A preferred embodiment of the invention provides in this context that the sensor body of the force sensor in the impact area of the training device, in particular boxing glove, is embedded in the training device in such a way that the sensor body is covered by a damping layer of constant thickness on a side facing the impact and possibly on a side facing away from the impact. Thus, regardless of the exact position of the punch onto the impact surface or in the impact area, the same results are measured for a given impact force.

Furthermore, it is advantageous if the sensor body rests against the damping layer everywhere so that it cannot slip and no undesired cavities can form between the sensor body and the damping layer. A preferred embodiment provides that the sensor body is connected to the damping layer in a materially bonded manner.

Depending on the type of training device, there can be several intended impact areas. For example, a boxing glove can be used to perform punches or backhand punches. Here, depending on the shape of the training device, it can happen that different thicknesses of damping layers of the damping material arise over the sensor body for different impact surfaces. As already stated, the different damping effects in the area of the different impact surfaces result in different measurement results of the force sensor for a given impact force. In order to be able to differentiate between these different types of punches (e.g. punch versus backhand punch) and thus different impact areas, the path of the punching movement can be calculated from the data of the acceleration sensor and the impact type can be deduced from the path. A corresponding calibration can now be carried out for each impact type and the associated impact area in order to calculate the correct force corresponding to the respective impact area for each measured pressure value. Thus, several impact areas can be covered with just one sensor body.

The invention further relates to a method for producing an inventive device, comprising the production of a damping layer of a training device from a foamed material, in particular plastic foam, and the embedding of a fluid-filled, elastically deformable sensor body in the damping layer, wherein a pressure sensor is arranged in the sensor body, which measures a fluid pressure.

According to a preferred method, the production of the damping layer comprises arranging a placeholder for the sensor body in a mold, foaming the mold with a foaming material and removing the placeholder after the foaming material has solidified, wherein the sensor body is inserted into the cavity formed by the removal of the placeholder.

According to a further preferred method, the production of the damping layer comprises arranging the sensor body in a mold and foaming the mold with a foaming material, thereby embedding the sensor body in the damping layer.

According to another preferred method, the sensor body has an elastic support structure in which the pressure sensor measuring the fluid pressure is arranged, wherein the production of the damping layer comprises the arrangement of the support structure in a mold and the foaming of the mold with a foaming material, wherein the foaming material upon hardening forms a closed skin around the support structure at the interface with the support structure, said skin forming an airtight shell of the sensor body around the support structure.

The invention is explained in more detail below with reference to exemplary embodiments shown schematically in the drawing. Therein,

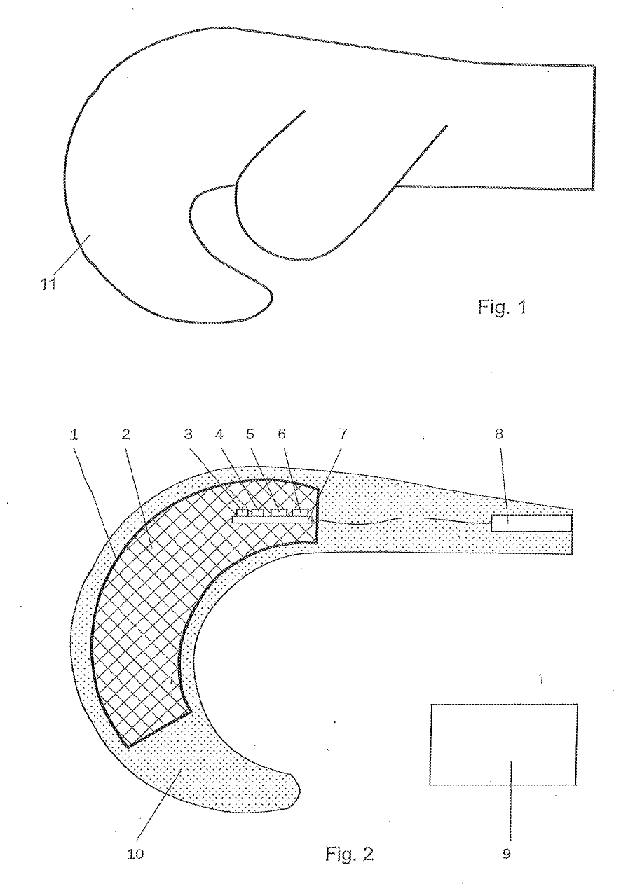

FIG. 1 shows a boxing glove in a side view,

FIG. 2 shows a foam core equipped with the device according to the invention in the interior of the boxing glove in cross section,

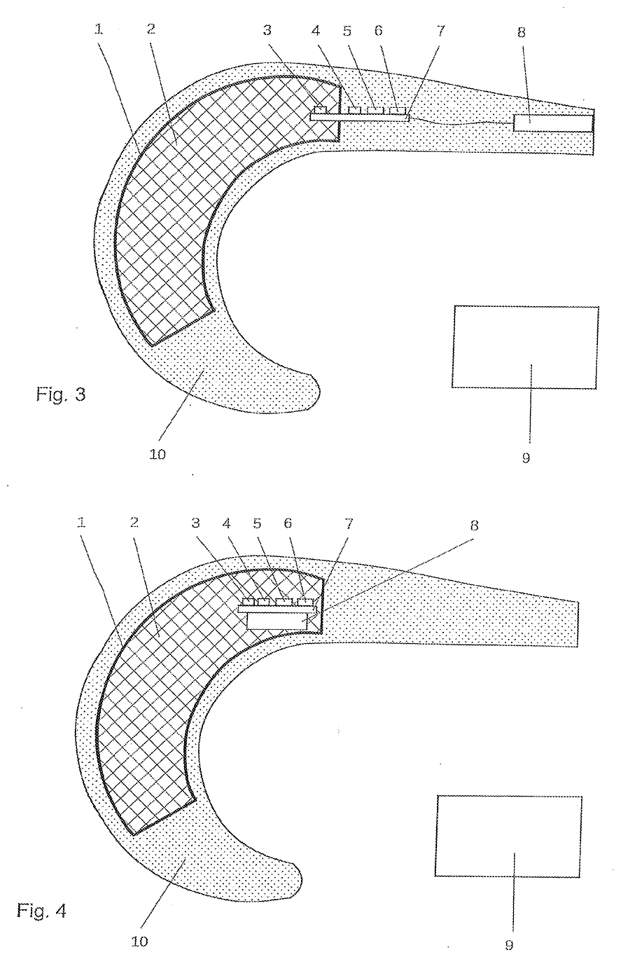

FIG. 3 shows a modified version of the foam core and

FIG. 4 shows another modified version of the foam core.

FIG. 1 shows a boxing glove 11, which has an area for receiving the thumb and another area for receiving the remaining fingers of the hand of a boxer. As is usual with boxing gloves, this includes a foam core 10, which is intended to protect the boxer's hand from injury.

As can be seen in FIG. 2, the foam core 10 is provided with a device for detecting the impact quality, comprising a force sensor and an acceleration sensor which are embedded in the interior of the foam core 10. The force sensor comprises a deformable sensor body 1 which has an airtight shell filled with a fluid, in particular a gas, preferably air, and an elastic support structure 2 filling the chamber enclosed by the shell. An (air) pressure sensor 3, the acceleration sensor 4, a microcontroller 5 and a wireless transmission unit 6 are arranged on an electronic circuit board 7 arranged in the interior of the sensor body 1, the electronic circuit board 7 being located completely in the interior of the sensor body 1 and is connected via a cable with a battery 8. The battery 8 is attached somewhat away from the striking surface, for example in the region of the cuff of the glove. With 9 a receiving and evaluation unit is designated. As can be seen from the figure, the shape of the sensor body 1 is adapted to the shape of the foam core 10, so that in front of and behind the sensor cushion (where front and back are to be understood in terms of the direction of impact) there is a constantly thick layer of the damping material of the foam core 10. This is important to obtain comparable results, regardless of the area of the boxing glove that is hit.

FIG. 3 shows a variant of the invention in which the entire electronic circuit board 7 is not accommodated in the interior of the sensor body 1, but only part of the circuit board protrudes into the sensor body, in particular the part on which the pressure sensor 3 is located. All other elements in FIG. 3 are constructed in a manner analogous to that in FIG. 2.

FIG. 4 shows a variant of the invention in which the battery 8 is also located inside the sensor body 1. All other elements in FIG. 4 are constructed in a manner analogous to that in FIG. 2.

The use of the invention in a boxing glove is shown as an example in FIGS. 1-4. The use in a punch pad, a protective vest, a foot protector or similar training utensils is analogous.

The boxing glove shown in FIGS. 1-4 can be produced in the following manner with the aid of the method according to the invention. According to a first variant of the method, when foaming the foam core 10, a placeholder of the same shape as the sensor body 1 is initially foamed and removed after the foam has cured. The complete sensor body 1 including the support structure 2 and the electronic circuit board 7 is then pushed (through a slot or the like) into the cavity that has remained free in the foam core 10.

According to a second variant of the method, a complete sensor body 1 including the support structure 2 and electronic circuit board 7 is foamed in at the same time as the foam core 10 is foamed. This guarantees a particularly precise fit of the sensor body 1 in the foam core 10.

According to a third variant of the method, only the support structure 2 together with the electronic circuit board 7 is foamed in during the foaming of the foam core 10, the foam of the foam core 10 forming a closed skin when it hardens, whereby the airtight shell of the sensor body 1 is formed around the support structure 2. Due to the intimate connection, this guarantees a precisely fitting and particularly firm fit of the sensor body 1 in the foam core 10.

1. A device for detecting the impact quality in contact sports comprising at least one force sensor for detecting a force acting on a training device and at least one acceleration sensor for detecting an acceleration of the training device, wherein the force sensor comprises a fluid-filled, elastically deformable sensor body, in which a pressure sensor is arranged for measuring the fluid pressure prevailing within the sensor body, wherein the detection unit is designed to evaluate the time series of the measured values of the acceleration sensor, in order to determine a trajectory, which is compared with predefined trajectories in order to determine an impact type, and wherein the detection unit is further designed to correct the measured values of the force sensor by using calibration data which are assigned to a corresponding impact type.

2. The device according to claim 1, wherein the sensor body comprises a gas-filled chamber which is surrounded by a flexible shell deformable by impact and which contains an elastic support structure, the support structure forming a damping element which mechanically dampens the forces that occur during impact.

3. The device according to claim 2, wherein the elastic support structure at least partially surrounds the pressure sensor.

4. The device according to any one of claims 1 to 3, wherein measured values of the force sensor and of the acceleration sensor are fed to a detection unit which is designed to record a time series of the measured values of the force sensor and the acceleration sensor.

5. (canceled)

6. The device according to any one of claims 1 to 4, wherein the acceleration sensor, the detection unit and/or a power storage is arranged inside the sensor body.

7. The device according to any one of claims 1 to 4 or claim 6, wherein the device further comprises the training device and wherein the force sensor and possibly the acceleration sensor are integrated, in particular embedded, in the training device.

8. The device according to claim 7, wherein the force sensor and the acceleration sensor are embedded, in particular sewn into, a boxing glove, a punch pad, a protective vest, a foot protector or a head protector as a training device.

9. The device according to any one of claims 1 to 4 or claims 6 to 8, wherein the force sensor and the acceleration sensor are surrounded by a damping layer, in particular a layer of plastic foam.

10. The device according to any one of claims 1 to 4 or claims 6 to 9, wherein the sensor body of the force sensor in an impact area of the training device, in particular boxing glove, is embedded in the training device such that the sensor body on a side facing the impact is covered by a damping layer of constant thickness, the sensor body preferably also being covered on a side facing away from the impact by a damping layer of constant thickness.

11. The device according to claim 10, wherein the sensor body is connected to the damping layer in a materially bonded manner.

12. A method for producing a device according to claim 1, comprising:
producing a damping layer of a training device from a foamed material, in particular plastic foam, and
embedding a fluid-filled, elastically deformable sensor body in the damping layer,
wherein a pressure sensor is arranged in the sensor body, which measures a fluid pressure.

13. The method according to claim 12, wherein the step of producing the damping layer comprises arranging a placeholder for the sensor body in a mold, foaming the mold with an foaming material and removing the placeholder after the foaming material has solidified, and wherein the sensor body is inserted into a cavity formed by the removal of the placeholder.

14. The method according to claim 12, wherein the step of producing the damping layer comprises arranging the sensor body in a mold and foaming the mold with a foaming material, thereby embedding the sensor body in the damping layer.

15. The method according to claim 12 or 14, wherein the sensor body has an elastic support structure in which the pressure sensor measuring the fluid pressure is arranged, wherein the step of producing the damping layer comprises the arrangement of the support structure in a mold and the foaming of the mold with a foaming material, wherein the foaming material upon hardening forms a closed skin around the support structure at the interface with the support structure, said skin forming an airtight shell of the sensor body around the support structure.
